(19) United States
(12) Patent Application Publication
(10) Pub. No.: US 2010/0033138 A1
(43) Pub. Date: Feb. 11, 2010

(54) CHARGING METHODS FOR NICKEL-ZINC BATTERY PACKS

(76) Inventors: Ethan Alger, Tracy, CA (US); Jeffrey Phillips, La Jolla, CA (US); Richard Bendert, Escondido, CA (US); Samaresh Mohanta, San Diego, CA (US)

Correspondence Address: Weaver Austin Villeneuve & Sampson LLP, P.O. BOX 70250, OAKLAND, CA, 94612-0250, US

(21) Appl. No.: 12/442,096

(22) PCT Filed: Sep. 21, 2007
(86) PCT No.: PCT/US07/79237

§ 371 Date: Oct. 2, 2009

Related U.S. Application Data
(60) Provisional application No. 60/846,518, filed on Sep. 21, 2006.

(51) Int. Cl. H02J 7/00

(52) U.S. Cl. 320/153

(57) ABSTRACT

A temperature compensated constant voltage battery charging algorithm charges batteries quickly and safely. Charging algorithms also include methods to recondition batteries after storage and to correct cell imbalances in a battery pack. A battery charger able to perform these functions is also disclosed.

### FIELD OF THE INVENTION

The present invention relates to the rechargeable battery arts and, more particularly to nickel zinc rechargeable battery cells and packs. Even more specifically, this invention pertains to methods of charging sealed nickel zinc rechargeable battery cells.

### BACKGROUND

The method of charging a nickel zinc battery is important to its performance. Performance factors such as battery life, specific capacity, charging time, and cost can all be affected by the method of charging. Charger designers must balance the need for a fast charge, therefore a quick return to service, and low cost charger with the other needs such as cell balancing, increasing life, and preserving capacity.

Nickel zinc battery charging poses particular challenges because the nickel electrode charging potential exists at a voltage very close to the oxygen evolution potential. During battery charging, the oxygen evolution process competes with the nickel electrode charging process as a function of the state-of-charge of the nickel electrode, charging current density, geometry, and temperature.

During the charging of a conventionally designed nickel zinc cell with excess zinc, oxygen evolution occurs before the nickel becomes fully charged. Nickel zinc batteries use membrane separators between the electrodes that limit the transport and oxygen access to the zinc electrode for direct recombination. Therefore, the rate at which oxygen can recombine at the zinc electrode is limited because the oxygen must travel to the ends of the electrode to cross the membrane separator. This challenge is particular to the nickel zinc battery because some other battery types, such as nickel cadmium batteries, do not employ separators having the same resistance to oxygen mobility. Thus, nickel zinc batteries are limited by their relatively lower oxygen recombination rates. In a sealed cell in the oxygen evolution regime, charging current density must not exceed the threshold above which oxygen would be created faster than the recombination within the cell, or oxygen pressure will build up.

Because of the oxygen evolution, the nickel zinc battery may require an “overcharge” to fully replace the nickel electrode's capacity. In other nickel battery types' charging schemes, this overcharge can be performed reasonably quickly. In the case for nickel zinc, however, the lower recombination rate limits the use of overcharging to cure the imbalance. Instead of overcharging at the rate of C/3 for nickel cadmium batteries, nickel zinc batteries can only overcharge at the rate of between C/100 and C/10, typically between 40 and 200 milliamps for 2 Amp-hour cells.

Classic charging schemes include constant potential and constant current. In order to avoid oxygen pressure build up in nickel zinc cells, a constant current scheme could necessitate too low of a current to allow fast charging. In a constant voltage scheme, cell imbalances are exacerbated to reduce the life of battery packs. When the voltage is constant, the weaker cell in series with stronger cells charges at a lower voltage than the stronger cells, further exacerbating its lower level of charge. Other charging schemes include multistage constant current schemes and pulse charge with discharge cycles. The more complex is the charging scheme, the more expensive is the charger.

After storage or shipping at high temperature, some battery packs are found to have high impedance, caused perhaps by a passivation layer on the electrode. These batteries will only charge slowly, because the high impedance allows only a low current at constant voltage. At a high constant current, these batteries quickly reach the voltage limit. In order to fast charge these batteries, the passivation layer must be removed to reduce the impedance.

What are needed, therefore, are charging methods that are fast, low cost, address charging imbalances among cells in a battery pack, charge batteries with high impedance, and are safe for the batteries and consumers.

### SUMMARY

The present invention provides novel charging schemes to quickly charge a nickel zinc battery pack, cure imbalanced cells in a battery pack, cure high impedance resulting during shipment or storage, and do all this safely and cheaply for the battery and the consumer.

Several charging schemes are presented: a bulk charge algorithm for charging most batteries; a front-end charge algorithm for manual and automatic reconditioning of batteries; an end-of-charge termination algorithm; a state-of-charge maintenance charge algorithm to ensure that the cell/battery is always charged while attached to a charger; and several alternate charge algorithms. Any of these may be used alone or in combination. A few preferred combinations are set forth herein, but the invention is not limited to these.

In one aspect, the present invention pertains to a method of charging a nickel-zinc battery at a constant current, then at a constant voltage. The method includes measuring a temperature of the battery, calculating a voltage based on at least the temperature of the battery, charging the battery at a constant current (CI) until the calculated voltage is reached, charging the battery at a calculated voltage (CV) per nickel-zinc cell, and stopping the charging at the calculated voltage per cell when an end of charge condition is satisfied. Note that there may be one or more cells in a battery. Typically, the cells are connected in series.

During the CI step, the battery is charged at, e.g., 1-2 Amps until either (a) the voltage is equal to or greater than a threshold voltage (which may be temperature compensated) multiplied by the number of cells being charged in series, (b) a specified time has elapsed (e.g., one hour), or (c) the temperature of the battery rises by a specified amount (e.g., about 15 degrees Celsius or higher). The battery temperature is optionally measured by a thermocouple, thermistor, or other temperature measurement device, typically located in the middle, or the thermal center, of the battery pack. Note that the parameter values listed here and elsewhere in this summary were chosen for a typical nickel zinc battery having a capacity of approximately 2 Amp-hours. Those of skill in the art will appreciate that some parameters values may be scaled with the battery capacity. In some embodiments, linear scaling is appropriate.

After the optional constant current stage of charging is complete, the bulk charging algorithm proceeds to the CV step. Here the battery is charged at the temperature compensated voltage multiplied by the number of cells until an end-of charge condition is satisfied. The end-of-charge condition may be that the current reduces to less than or equal to a set value (e.g., about 90 milliamps per cell), a set time has elapsed (e.g., about 1.5 hours), the current is greater than or equal to a defined threshold value associated with a short circuit in the battery (e.g., about 2.25 Amps for a 2 Amp-hour battery), the temperature rises by a defined amount (e.g., about 15 degrees Celsius or more—e.g., to an temperature of 37 degrees Celsius), or a combination of these.

The temperature compensated voltage is a function of the battery temperature and, in some embodiments, a percentage state-of-charge, electrolyte composition, and the constant stage charge current. Depending on the sophistication of the charging hardware, temperature compensation equations of varying complexity may be used. In one embodiment, the charger employs a quadratic equation, but other embodiments include a linear equation or two linear equations for different temperature ranges, as shown in Table 1. Equations for various states of charge (identified as percentages of complete charge) are provided. Once the temperature compensated voltage is determined, it is used in the bulk charge algorithm (e.g., as the voltage cutoff for the constant current stage of the charge process). The algorithm will update temperature compensated voltage as the battery temperature changes over time during charging. In certain embodiments, the temperature compensated voltage used during the CV phase is about 1.9 to 1.94 volts. In certain embodiments, this voltage is appropriate for use when the cell being charged has a temperature in the range of about 20-25 degrees Celsius, preferably about 22 degrees Celsius. Further, the 1.9 to 1.94 voltage may be appropriate for nickel-zinc batteries having electrolytes with a free unbuffered alkalinity of between about 5 and 8.5 molar. In certain embodiments, an expression used for temperature compensated voltage during the CV phase is _V=−0.0044*T+2.035 where V is the constant voltage value and T is the temperature in degrees Centigrade.

In certain embodiments employing nickel zinc cells employing high conductivity electrolytes, e.g., electrolytes having a conductivity in the range of about 0.5 to 0.6 (ohm cm)⁻¹, the constant voltage employed during the CV phase may be reduced by some amount. In one embodiment, the CV set voltage is reduced by about 10 to 20 millivolts compared with the level described above. Thus, in some cases, the set voltage during the CV phase may be about 1.88 to 1.92 volts. Similarly, the transition from CI to CV may occur when the cell voltage reaches about 1.88 to 1.92 volts during the CI phase in charging a nickel zinc cell.

In a particular embodiment, the charging method includes a front-end charge algorithm that checks first for battery temperature to be within a certain range, e.g., between about 0 and 45 degrees Celsius. If the temperature is outside this range, then the algorithm will apply a trickle current or equivalent current pulse between about 100 to 200 milliamps per 2 amp hour of battery capacity until the temperature rises to about 15 degrees Celsius (or other specified temperature), voltage reaches a minimum of, e.g., one volt per cell, or the time limit of, e.g., about 20 hr @ C/20 rate is reached without the temperature increase or minimum voltage. If the temperature is within the range, then the front-end charge algorithm is skipped and the constant voltage or constant current/constant voltage charging may start.

In certain embodiments, a front-end algorithm may be activated automatically by the charger logic or manually, e.g., by the user pressing a reconditioning button. If the constant current step of the bulk charge algorithm reaches its voltage endpoint (e.g., 1.9 volts) too quickly, e.g., within 0-10 minutes, preferably within 5 minutes, then the front-end algorithm may start automatically to recondition the battery pack. This algorithm has been found to be helpful for those batteries having a high impedance resulting from, possibly, passivation during storage or shipping. The lower-than-normal current provided in the front-end charge may reform the electrode components and thereby remove a passivation layer (e.g., a passivation layer on the zinc electrode).

An end-of-charge termination algorithm may be added after the end-of-charge condition is satisfied or may be implemented by a charger when a battery pack has greater than about 90% state-of-charge. In one embodiment, the end-of-charge termination algorithm comprises of a first corrective current between about 50 to 200 milliamps per 2 amp hour of battery capacity for about 30 minutes to 2 hours, preferably at about 100 milliamps per 2 amp hour of battery capacity for about 1 hour. There is no voltage limit for this step. This algorithm is found to at least partially overcome cell imbalances in a battery pack. The fixed current forces a certain level of current to pass through each cell equally—thus allowing weaker cells to charge to a level not necessarily attained with constant voltage and thereby reducing differences between strong and weak cells. The algorithm has been found to increase battery life.

The state-of-charge maintenance algorithm can be used to ensure that the cell/battery has, e.g., about 80% or greater state-of-charge while attached to a charger. This algorithm may be a second half of the end-of-charge termination algorithm after the corrective current or may stand alone. One embodiment of this algorithm employs a constant current charge of about 0-50 milliamps per 2 amp hour of battery capacity or equivalent current pulsing. In another embodiment, the battery pack can receive a full charge cycle (standard charge algorithm) periodically if the voltage of the pack is between, e.g., about 1.71V to 1.80V per cell.

The temperature compensated voltage used in some of the algorithms may be recalculated constantly or periodically. Thus the voltage applied during the constant voltage phase may change as the battery temperature changes. The temperature measuring and calculating operations of the charging method may thus repeat during charging.

Certain alternative charge algorithms may include a multi-stepped constant charge algorithm to defined voltage limits (e.g., temperature compensated voltage limits). In some examples, about ten steps are used. In one example, a constant current is applied initially until the voltage reaches the defined voltage limit. Then the current is stepped down by a defined factor until the voltage again reaches the defined limit. The process may repeat until a defined level of charge is reached. This approach may be employed in cases where very simple chargers are employed, e.g., chargers that are incapable of performing a constant voltage charge. This method of charging a battery includes measuring a temperature and a voltage of the battery, calculating a calculated voltage based on at least the temperature of the battery, charging the battery at a charge current until the battery voltage equals the calculated voltage, reducing the charging current by a defined factor, and charging the battery at the reduced charge current until the battery voltage equals the calculated voltage. The reducing current and charging the battery at the reduced charge operations may be repeated until the current is below a certain amount, signifying that a certain capacity is reached. The defined factor may be about 2-10. This factor may be kept constant in some or all of the steps, or may be varied from step to step. The calculated voltage may be updated continuously by measuring the temperature and recalculating the voltage. In some embodiments, measuring of temperature and voltage occurs periodically, e.g., once every 5 seconds. In some embodiments, these measurements occur independently of each other.

Certain other alternate charge algorithms involve using a constant current and terminating the charge based on measured voltage, voltage and time, and/or temperature and time. In the first case the charge is terminated when the voltage level decreases by dV from the maximum, which may be about 0 to 0.020 volts/cell in certain embodiments, preferably about 0 volts/cell. In other words, the charge stops preferably at the inflection point where the voltage stops increasing and is just starting to decrease from the maximum. In a second case, the charge is terminated when the level of voltage decreases relative to time by the amount dV/dt. In other words, the charger will terminate the charge when voltage decreases by a pre-determined amount per cell within a specified time period. Alternatively, the charge may be terminated when the level of voltage does not change over a certain amount of time. Lastly, the charge may be terminated based on the amount of temperature increase relative to time, or dT/dt. In other words, the charger will terminate the charge when the battery temperature increases by a specified amount within a specified time period.

In certain embodiments, a method of charging a nickel-zinc cell may include charging the nickel-zinc battery at a constant current until reaching a point at which (i) the cell's state of charge is at least about 70%, (ii) a nickel electrode of the cell has not yet begun to evolve oxygen at a substantial level, and (iii) the cell voltage is between about 1.88 and 1.93 volts or between about 1.88 and 1.91 volts; and charging the nickel-zinc battery at a constant voltage in the range of 1.88-1.93 until an end-of-charge condition is satisfied. In some cases, the constant current may be most about 4 Amps per 2 Amp hour battery capacity when the nickel-zinc battery employs an electrolyte having a conductivity of at least about 0.5 cm⁻¹ ohm⁻¹. In some embodiments, a lower constant current may be used, at about 2 amps or at about 1.5 amps. Note that in this embodiment, no measurement of cell temperature or calculation is necessary.

Any one or more of the charging methods described herein may be employed on chargers singly or in combination. The logic required may be hardwired into the charger by using various electronic components, be programmed with a low cost programmable logic circuit (PLC), or be custom designed on a chip (e.g., an ASIC). Also the charger may be integrated into a consumer product, such as where the logic is programmed into the power tool or device powered by the battery. In some of these cases, the logic may be implemented in the electric circuitry directly integrated into the consumer product, or be a separate module that may or may not be detachable.

The present invention also pertains to a nickel-zinc battery charger. The charger may include an enclosure for holding the nickel-zinc battery, a thermistor configured to thermally couple to a battery during operation, and a controller configured to execute a set of instructions. The charger may also include a recondition button. The enclosure need not completely surround the battery, e.g., the enclosure may have an open face. The enclosure may also have a door or lid to allow for easy access to the battery. During charging operations, the thermistor may contact an external surface of a cell in the thermal center of a battery pack. The set of instructions may include instructions to measure a temperature of the battery, calculate a calculated voltage, charge the battery at the calculated voltage, and stop the charge at the calculated voltage when an end-of-charge condition is detected. The instructions may also include instructions to charge the battery at a constant current, charge the battery at a corrective current, or charge the battery at a minimum current. The instructions may also include instructions to charge the battery at an initial current when the recondition button is pressed. Additionally, the charger may include other interface with which the user may interact with the charger or the charger may communicate with the user, e.g., color lights to indicate completion of charging or that the battery is bad.

These and other features and advantages of the invention will be described in more detail below with reference to the associated drawings.

### BRIEF DESCRIPTION OF THE DRAWINGS

FIG. 1 is a simple schematic of a charger connected to a battery pack in accordance with the present invention.

FIGS. 2A and 2B are graphs of charge curves at various battery temperatures of constant current charging at 1 Amp and 2 Amps, respectively.

FIG. 3 is a graph of charge curves for various electrolyte compositions.

FIG. 4 is a graph of a constant current/constant voltage charge algorithm over time in accordance with some embodiments of the present invention.

FIG. 5 is a graph of a battery charging algorithm over time in accordance with some embodiments of the present invention.

FIG. 6A is an exploded diagram of a nickel zinc battery cell in accordance with the present invention.

FIG. 6B is a diagrammatic cross-sectional view of an assembled nickel zinc battery cell in accordance with the present invention.

FIG. 7 presents a diagram of a cap and vent mechanism according to one embodiment of the invention.

### DETAILED DESCRIPTION OF THE PREFERRED EMBODIMENTS

### Introduction

In the following detailed description of the present invention, numerous specific embodiments are set forth in order to provide a thorough understanding of the invention. However, as will be apparent to those skilled in the art, the present invention may be practiced without these specific details or by using alternate elements or processes within the spirit and scope of the invention. In other instances well-known processes, procedures and components have not been described in detail so as not to unnecessarily obscure aspects of the present invention.

Although many charging schemes are presented, it should be understood that not all charging methods need to be configured on the same charger. A charger may employ these methods singly or in combination. Further, a charger may or may not allow user interaction to provide manual selection of a charging algorithm or even selection of a parameter within a particular charging algorithm. Particularly, a “recondition” button may be provided which the user may select to start the front-end charge algorithm. For truly low cost chargers, user interaction with the charger may be limited to little if any manual input, relying instead on the logic of the charger.

A battery may include one or more cells. If more than one cell, the cells are electrically connected to each other serially. In this disclosure, the terms battery and “battery pack” are used interchangeably. Unless otherwise noted, parameters specified herein pertains to a 2 Amp hour cell.

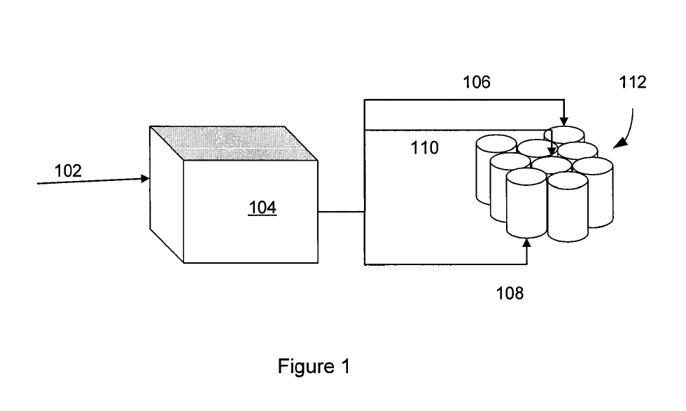

FIG. 1 shows a simple schematic of a charger 104 connected to a 9-cell battery pack. In the depicted embodiment, a variable alternating current 102 enters the charger 104, which is wired to a positive terminal 108 and a negative terminal 106. The cells are wired in series. A thermocouple or a thermistor 110 is attached to the center of the battery pack and provides temperature inputs to the charger 104.

Bulk Charge Algorithm with Temperature Compensation (CI/CV)

A bulk charge algorithm applies to many charging situations. It is fast and cost effective. If unmitigated, oxygen evolution is particularly problematic in nickel-zinc battery cells. The bulk charge algorithm generally includes at least two stages, a constant current (CI) stage where the majority of charging, e.g., up to 80% state-of-charge, takes place and a constant voltage (CV) stage where efficient charging takes place while taking into account the oxygen evolution. The constant voltage (CV) charging at or below a voltage at which the oxygen evolution/recombination reactions may be sustained in balance without undue increase in cell pressure and/or temperature. In certain embodiments, the CI stage is performed in a step-wise manner, which each succeeding step performed at a lower current.

During the CI step, the battery is charged at a constant current (e.g., about 1-2 Amps) until one of various conditions is satisfied. The desired condition is that the charging reaches a defined voltage (e.g., about 1.9 volts/cell) within a reasonable and expected time frame. In particular embodiments, the defined voltages are temperature compensated. This defined voltage may correspond to a state-of-charge at about 70-80%, or preferably about 80%. In certain embodiments, the defined voltages depend on battery temperature, electrolyte composition (e.g., alkalinity) and the initial constant charge current. After the voltage threshold condition is satisfied, then the battery transitions to charging in the CV step.

The temperature compensated voltage is a function of the battery temperature and a percentage state-of-charge. The complexity of the temperature compensation calculation may be dictated by the level of sophistication of the charger (and consequently its expense). Its value is defined by using, e.g., a quadratic equation, a linear equation, or two linear equations for different temperature ranges (above and below 20 degrees Celsius). Table 1 shows the constant values for each equation for different percentage state-of-charge between 50 and 90 percent. The equations are:

Quadratic: a(T)²+b(T)+c

Linear: m(T)+V

where T is the measured temperature and a, b, c, m, and V are constants provided in Table 1. For sophisticated chargers, the quadratic equation may be desirable, as it may closely approximate the temperature compensated voltage. However, the linear equations are likely used in implementation when the charger is limited to simpler logic (which is expected to be the situation with inexpensive chargers (e.g., about US$5/charger)).

An important consideration in choosing the appropriate voltage for the termination of the constant current phase of the charge is the time required for charging. It is desirable to charge batteries quickly, so that the battery operated device may return quickly to service. Because charge transfer to the battery is typically higher during the CI step than during the CV step, it is desired that bulk of the charging takes place in the CI step. However, oxygen evolution becomes a concern after continued charging in the CI regime. For single cells this value may be chosen at a voltage corresponding to the measured charge voltage at a given current at approximately 70-80% state of charge, depending on factors such as battery temperature and constant charging current. For multicell batteries the voltage value chosen may correspond to a lower state of charge, i.e., 50 to 70% depending on the initial Amp hour capacity distribution spread and how that spread may change over the cycle life of the battery. The state-of-charge at which the CI step is terminated may be limited to a point at which the onset of oxygen evolution occurs during the constant current charge curve taking into account the capacity distribution in a battery pack. Appropriate values of the voltage and their temperature dependence are illustrated in Table 1.

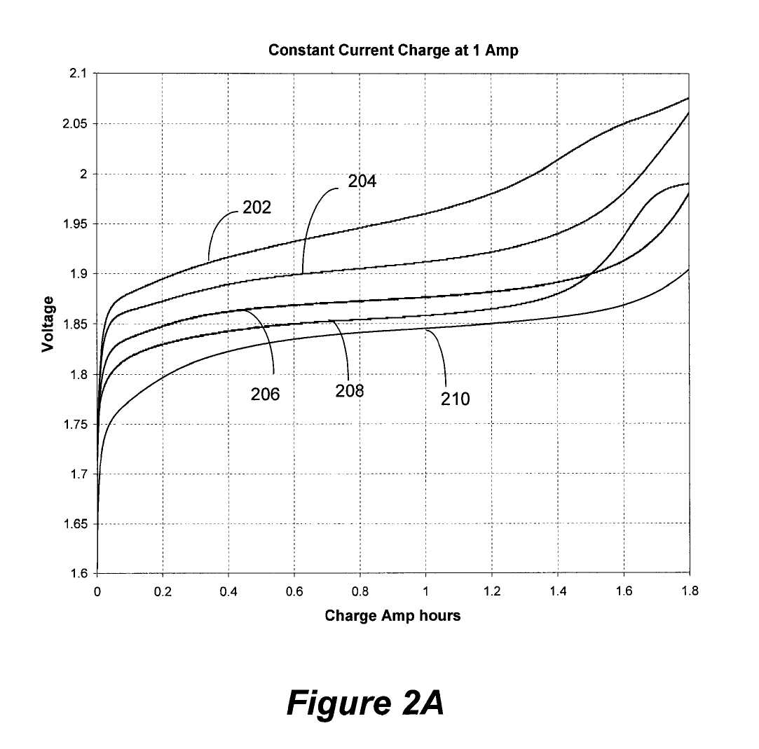

FIG. 2A is a graph of charge curves at various battery temperatures of constant current charging at 1 Amp. The graph shows battery voltage versus amp hours charged for 1.8 amp hour nickel zinc cells at temperatures of 0 to 40 degrees Centigrade. Curve 202 corresponds to the charge curve at 0 degrees Centigrade. The voltage increased quickly after very little charging and increases from about 1.87 volts to about 2.075 volts at 1.8 amp hours, corresponding to 100% state-of-charge (SOC) for these cells. Curve 204 corresponds to the charge curve for a battery temperature of 10 degrees Centigrade; curve 206, 20 degrees; curve 208, 30 degrees; and, curve 210 at 40 degrees Centigrade. As the battery temperature increased, a lower voltages correspond to the same charge capacity. For example, at about 1 amp hour, corresponding to 56% SOC for a 1.8 amp hour battery, the battery voltage is about 1.845 volts for the 40° C. battery. As the battery temperature decreases the voltage became higher and higher at the same SOC. Note that the curves have an “s” shape or upward trend (increasing slope) after a relatively flat plateau. This upward trend generally occurs at relatively higher charged capacities. Though not intended to be bound by this theory, it is believed that the onset of the upward trend indicates the beginning of undesirable oxygen evolution rate. Generally, battery pressure does not significantly increase and cause a safety concern until the charged capacity is over 100%. However, even some oxygen evolution in excess of the recombination rate may affect the longevity of internal parts and render the charging less effective because not all electrical energy is converted and stored as electrochemical energy. Thus, the battery voltage is desirably kept below this onset voltage during the entire bulk charging process by switching to a CV step after the CI step reaches this voltage.

The temperature compensated voltage may also depend on the electrolyte composition and the constant charging current. Generally, a lower constant charging current reduces the defined voltage at which the charging transitions to the CV regime. FIG. 2B is a graph of charge curves at various battery temperatures of constant current charging at 2 Amp. As with the experiments of FIG. 2A, these experiments were conducted with nickel zinc cells having a capacity of 1.8 amp hours. Charging curve 212 corresponds to a battery charged at 0 degrees Centigrade; curve 214, 20 degrees; curve 216, 30 degrees, and, curve 218, 40 degrees Centigrade. Compared to FIG. 2A, the voltages are generally higher, about up to 30 millivolts or even up to 50 millivolts higher. Note that the point where voltage starts to increase at a higher rate occurs at a lower charged capacity. Thus, the SOC at the transition between CI and CV may be lower if the constant current is higher (e.g., 2 amps versus 1 amp). Although charging at a higher current generally means that the charge is quicker, this may not always be the case. High current CI charging may actually result in a longer total charge time if the CI stage must be terminated at a relatively low SOC due to oxygen evolution considerations. In such cases, the charge must transition to the relatively slower CV stage earlier in the overall charge procedure. A specific example may illustrate the point. At a constant current of 2 A, a battery may initiate the CV step at about 60% capacity, which occurs after 40 minutes of charging. However, the remaining 40% capacity with the CV step can take over an hour. At constant current of 1 A, a battery may initiate the CV step at about 80% capacity after charging for about 1.5 hours. The remaining 20% capacity may take half hour more. The difference in total charging time between a constant current of 1 A and 2 A may be about half an hour. An optimal constant current for the CI step may be between 1 and 2 amps for this 1.8 amp hour cell, or about 1.5 amps. The difference between the temperature compensated voltage of constant currents at 2 amp and 1 amp may be up to about 30 millivolts or up to about 50 millivolts. The difference between the temperature compensated voltage of constant currents at 2 amp and 0.133 amp may be up to about 80 millivolts.

TABLE 1
Example Temperature Compensation Constants
Temperature Compensation Data Table
Vcomp = aT\hat{ }2 + bT + c

| % | | | | |
|---|---|---|---|---|
| SOC | a | b | c | equation |
| 50 | 8.00E−05 | −0.0079 | 2.0382 | y = 8E−05 T² − 0.0079T + 2.0382 |
| 60 | 8.00E−05 | −0.0079 | 2.047 | y = 8E−05 T² − 0.0079T + 2.047 |
| 70 | 7.00E−05 | −0.0077 | 2.0548 | y = 7E−05 T² − 0.0077T + 2.0548 |
| 80 | 5.00E−05 | −0.0068 | 2.0593 | y = 5E−05 T² − 0.0068T + 2.0593 |
| 90 | 3.00E−05 | −0.0056 | 2.0651 | y = 3E−05 T² − 0.0056T + 2.0661 |

Vcomp = mT + V (2 equations for > or < 20 C.)

| | | |
|---|---|---|
| % | 20 C. or below | 20 C. or above |

| SOC | m | V | m | V |
|---|---|---|---|---|
| 50 | −0.0066 | 2.037 | −0.0023 | 1.952 |
| 60 | −0.0066 | 2.046 | −0.0024 | 1.960 |
| 70 | −0.0065 | 2.054 | −0.0025 | 1.970 |
| 80 | −0.0057 | 2.058 | −0.0028 | 1.988 |
| 90 | −0.0048 | 2.065 | −0.0034 | 2.026 |

Vcomp = mT + V (all temperatures)

| % | | | |
|---|---|---|---|
| SOC | m | V | equation |
| 50 | −0.0041 | 2.0159 | y = −0.0041T + 2.0159 |
| 60 | −0.0042 | 2.0254 | y = −0.0042T + 2.0254 |
| 70 | −0.0044 | 2.0353 | y = −0.0044T + 2.0353 |
| 80 | −0.0044 | 2.0453 | y = −0.0044T + 2.0453 |
| 90 | −0.0043 | 2.0587 | y = −0.0043T + 2.0587 |

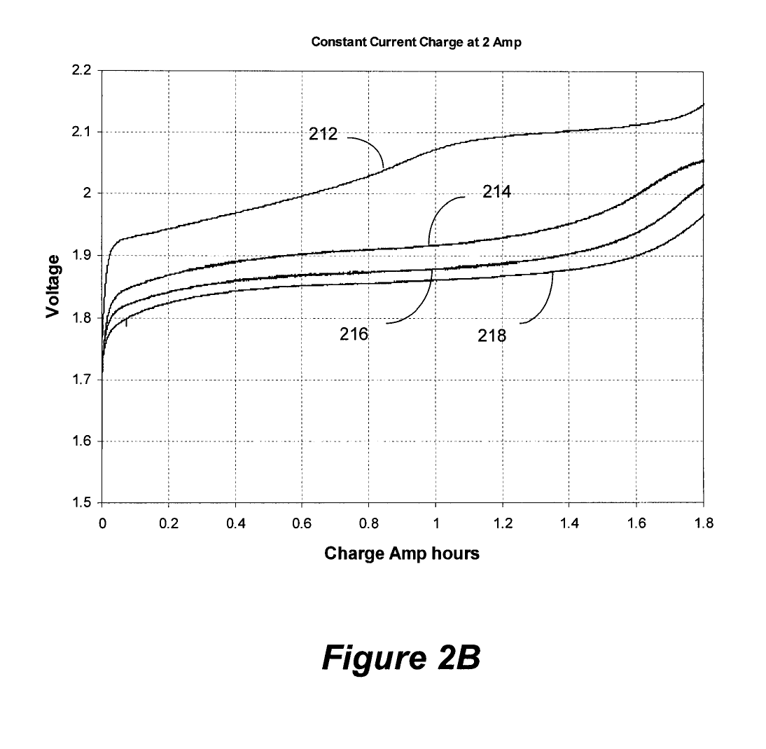

Increased electrolyte conductivity may reduce the defined voltage for transition from the CI to the CV charge stage. FIG. 3 is a graph of charge curves for various electrolyte compositions. The electrolyte may be characterized by its conductivity and alkalinity. The composition of the electrolytes in FIG. 3 are summarized in Table 2. Compositions A and E have the highest alkalinity, followed by compositions B, C, and D. Compositions A-D have similar conductivity, but composition E is lower. The charge curve for composition E is 301; for composition A is 303; for B, 305; for C, 307; and, for D is 309. FIG. 3 shows that the charge curve 401 for composition E reaches the highest voltages earliest during the constant current charging at 2 amps. Thus, in some embodiments the voltage during the CV stage may be decreased in cells employing electrolytes having relatively higher conductivity. Comparing the charge curves of compositions A to E suggests to the inventors that nickel zinc cells having an electrolyte conductivity of about 0.5 to 0.6 (ohm cm)⁻¹ may proceed to a the CV phase at a lower cell voltage, e.g., about 10-20 millivolts lower than would be otherwise appropriate for a nickel zinc cell employing electrolyte having a lower conductivity, e.g., one in the range of about 0.35 to 0.45 (ohm cm)⁻¹. In some but not all cases, constant voltage during the CV stage may also be conducted at a lower set voltage (e.g., in the range of about 1.88 to 1.91 volts).

In general, the conductivity of an electrolyte is a complex function of the electrolyte components. Some components of the electrolytes in FIG. 3 are presented in Table 2. Alkalinity is one, but far from the only, driving factor in electrolyte conductivity.

TABLE 2
Electrolyte Compositions Tested in FIG. 3

| Electrolyte | A | B | C | D | E (Std) |
|---|---|---|---|---|---|
| Phosphate (M) | 0.1 | 0.1 | 0.1 | 0.1 | |
| Borate (M) | | | | | 0.3 |
| Fluoride (M) | 0.28 | 0.28 | 0.28 | 0.28 | 0.28 |
| Alkalinity (M) total | | | | | |
| Sodium hydroxide (M) | 0.84 | 0.84 | 0.84 | 0.84 | 0.84 |
| potassium hydroxide (M) | 6.73 | 5.73 | 5.23 | 4.73 | 6.73 |
| lithium hydroxide (M) | 0.4 | 0.4 | 0.4 | 0.4 | 0.4 |
| Conductivity (ohm cm)⁻¹ | 0.53 | 0.54 | 0.53 | 0.53 | 0.4 |

In summary the voltage values are dependent upon at least the conductivity of the electrolyte, the charging current, the number of cells in the battery and the battery temperature. In one embodiment, constant currents for a fast charge are between 1 A and 2 A for a 2 Ah battery.

In operation, the temperature compensated voltage may be continuously calculated from the updated temperature measurement of the battery pack. One preferred way to measure temperature is from a thermocouple or thermistor located in the thermal center of the battery pack, but other methods may be used. Depending on charger design, temperature measurement may be taken intermittently, as in once every minute or a few seconds, or continuously if the logic circuit would permit. To manage the oxygen evolution during battery charging operations at constant voltage, temperature-compensated voltage for about 70-80% state-of-charge may be used.

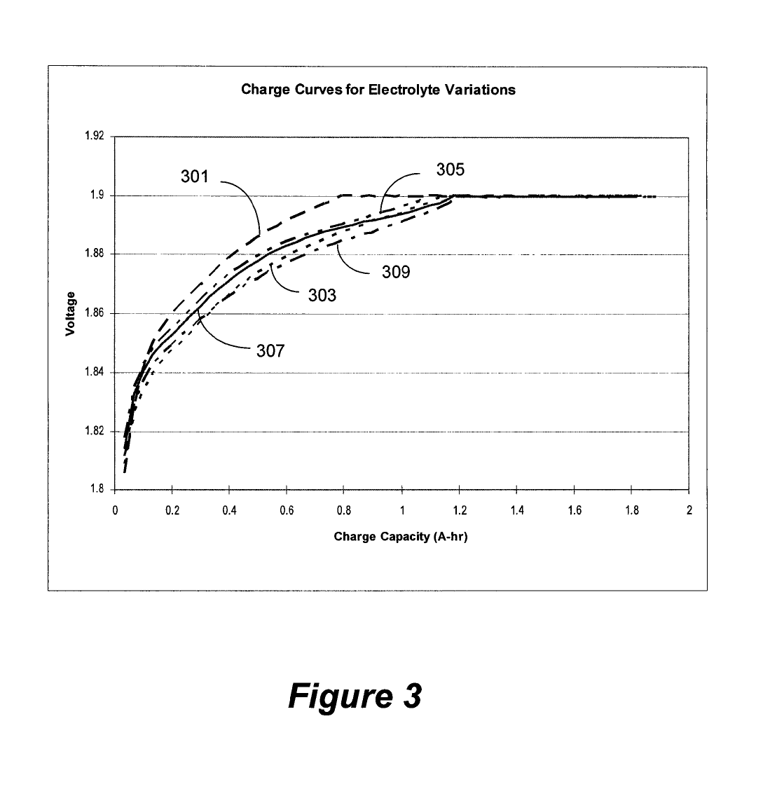

FIG. 4 is graph of a constant current/constant voltage charge algorithm over time in accordance with one embodiment of the present invention. Current is shown on the left y-axis; voltage is shown on the right y-axis. Curve 402 shows the current through the battery pack (6 cells, each having a capacity of approximately 2 Amp-hours) over time. At time 0, the current starts at 2 amps and stays constant until voltage 404 reaches about 1.9 volts, at about 2200 seconds for the cell tested. The initial voltage gain is very steep, and then the rate of voltage gain starts to decrease at about 200 seconds. The voltage increases almost constantly in this regime, and is then followed by another rate increase. This period, from about 200 second to 2100 seconds (in the graph), is the regime of most efficient charging. The charging battery pack gains most of its stored capacity during this period. As the curve slope increases again, it reaches a shoulder right around the temperature compensated voltage. This shoulder signals the beginning of oxygen evolution.

The second condition that may signal the end of the constant current step is a defined elapsed time (e.g., the constant current phase ends after one hour has elapsed). It is anticipated that most battery packs will reach the temperature compensated voltage within one hour. If after one hour the voltage is still less than the temperature compensated voltage, one of various problems may have occurred: the battery may have developed an internal short circuit, the charger measurements may be faulty, or some other battery internal problems may have developed. In that case the algorithm will not go to the CV step. User intervention may be required.

A third condition that may signal the end of the constant current step is if the battery temperature rises by at least a particular defined amount—e.g., about 15 degrees Celsius or more. Just like the second condition, the excessive temperature rise signals something may be wrong with the battery pack. Even though nickel zinc batteries are less prone to thermal runaways that may plague other battery types, excessive thermal energy may mean that oxygen pressure is building up or higher than normal rates of recombination is occurring. It may also mean that the cell has developed a short. When excessive temperature rise has been detected, the charging algorithm will stop the charging until the user intervenes. The charge can be restarted once the temperature is within acceptable bounds. If the problem repeats then the battery should be disposed of.

The second step in the CI/CV bulk charge algorithm is the constant voltage step. During this step, the battery continues charging at the defined voltage (e.g., a temperature compensated voltage) until one of several conditions is satisfied. The first condition is where the current reduces to below a defined level (e.g., 90 milliamps for a 2 Amp-hour cell). This low current signals that the charging is complete because very little electrical energy is now being converted into chemical energy. The charge is stopped at this point because the battery is almost fully charged, denoted as state of charge (SOC) at 100%. In other embodiments, different current levels may be used as the stop point in order to target different percentages of SOC. After this condition is satisfied, the charging algorithm would end normally.

As seen in FIG. 2, the battery cell is held at around 1.9 volts during this step, from about 2200 to 5000 seconds, as shown on curve 204. The current 202 drops steadily initially and levels out slowly. As noted above, during this step oxygen evolution would start. The rate of charge has to be at such a level that oxygen pressure does not build up significantly.

The second condition that may signal the end of the constant voltage step is when 1.5 hours has elapsed. It is anticipated that battery packs employing 2 Amp-hour cells will reach 90 milliamps within about 1.5 hours. However, if after 1.5 hours the current is still higher than 90 milliamps, the charge is terminated normally. This is not a safety limit just an alternate limit.

Just as in the CI step, various safeguard conditions may be built in to ensure the battery is not overcharged or defective. A third condition that may signal the end of the constant voltage step is if the battery temperature rises by a defined amount such as 15 degrees Celsius or more relative to a start time. The start time may be the beginning of battery charging or the beginning of any of the algorithmic steps. Possible problems are the same as the discussion in the CI step. The last condition is if the current increased to an unexpectedly high value of, e.g., 2.25 amps or more. This high current might signal an internal short circuit.

Understand that many of the specific parameter values recited here (e.g., maximum current, time cutoffs, and temperature compensated voltage constants) are for nickel zinc cells of a particular capacity. Specifically, the recited values are directed to nickel zinc cells having approximately a 2 Amp-hour capacity configured in series in a 6-cell battery pack. Some of the values will have be scaled for cells and battery packs of different capacities, as will be understood by those of skill in the art.

### Front-End Charge Algorithm

Various “front-end” charge algorithms may be employed prior to bulk charging. One class of such algorithms provides diagnostic tests designed to make sure that the battery can be successfully charged using the standard charge algorithm. The front-end algorithm may be implemented before every charge, automatically, or by user initiation.

In one embodiment, a front-end charge algorithm checks first for battery temperature within an acceptable range for bulk charging (e.g., between about 0 and 45 degrees Celsius). Bulk charging will not be initiated if the temperature is outside this range. In such cases, the algorithm will apply a “trickle” current or equivalent current pulse between about 50 to 200 milliamps per 2 Amp-hour capacity until the temperature rises to an acceptable level for bulk charging (e.g., about 15 degrees Celsius), and/or the cell voltage reaches a minimum of 1 volt per cell, and/or a specified time limit is reached (e.g., about 20 hours have elapsed). When the minimum voltage and/or the temperature is reached, the bulk charge algorithm may start.

In certain embodiments, this algorithm has the voltage and temperature conditions in the disjunctive. For example, it will be satisfied if either the battery is at least 15 degrees Celsius or even the voltage is at least 1 volt. Under normal operating conditions, both of these will be satisfied. The algorithm is likely used only when the battery is initially charged, after long-term storage, or the battery is suspected of being damaged. If neither condition is satisfied before the time limit occurs, the standard charge algorithm should not begin. If the voltage is below the limit the battery needs to be replaced. If the battery is below the temperature limit, the charge may be reset.

This algorithm may also be triggered when the voltage reaches the temperature compensated voltage cut off of the CI step in the standard charge algorithm too fast. A 2 Amp-hour battery charged at 2 Amps would normally reach its temperature compensated voltage in between 30 to 60 minutes, but if a passivation layer causes high impedance in the battery, then the time may be reduced to between 0 and 20 minutes. Alternatively, this front-end algorithm may be activated by the user pressing a button to recondition the battery (or otherwise manually initiating). This algorithm has been found to be helpful for those batteries having a passivation buildup. The lower-than-normal current reforms the electrochemical components and thereby removes the passivation layer.

### End-of-Charge Termination Algorithm

An end-of-charge termination algorithm may be added to the end of the standard charge algorithm. In one embodiment, the end-of-charge termination algorithm comprises applying a corrective current between about 50 to 200 milliamps for about 30 minutes to 2 hours, preferably at about 100 milliamps for about 1 hour (again assuming a nominally 2 Amp-hour cell). These currents may be scaled for cells having a different capacity. This additional operation is initiated after the constant voltage portion of the charging algorithm is completed. In a typical application, there is no voltage limit for this step.

In another embodiment, the end-of-charge termination algorithm comprises more than one constant current step. The first step may apply a constant current between about 50 to 200 milliamps for about 30 minutes to 2 hours, preferably at about 100 milliamps for about 1 hour; and the second step would comprise of constant current between about 0 and 50 milliamps for as long as the battery remains on the charger.

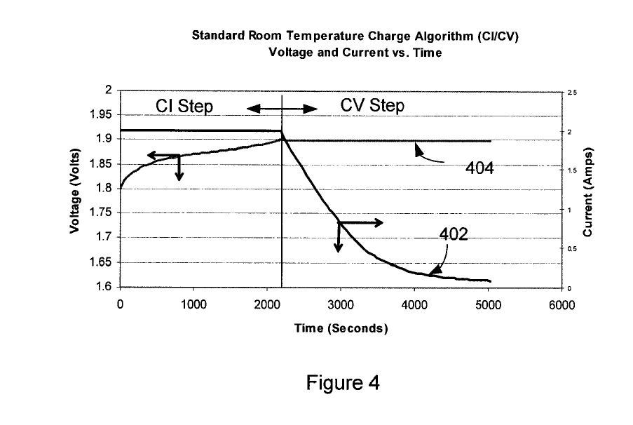

FIG. 5 shows the addition of an end-of-charge algorithm to the bulk charging algorithm. After the constant voltage CV step, current is held constant in the last CI regime, in the graph after 5000 seconds. Current 502 is held constant at about 100 milliamps, and voltage 504 slowly increases to a little over 2 volts. This algorithm is found to at least partially overcome cell imbalances in a battery pack. The fixed current forces a certain level of current to pass through each cell equally—thus allowing weaker cells to charge to a level not necessarily attained with constant voltage and thereby reducing differences between strong and weak cells. The algorithm is found to increase battery life.

### State-of-Charge Maintenance Algorithm

The state-of-charge maintenance algorithm can be used to ensure that the cell/battery has, e.g., 80% or greater state-of-charge while attached to a charger. This way, a user can inadvertently leave the charger plugged in for days, weeks, or months and when she retrieves a battery from the charger it will be nearly fully charged and ready for use. One embodiment of this algorithm is to use a constant current charge of between about 0 to 50 milliamps or equivalent current pulsing. This constant current charge would be applied without a voltage limit for as long as the battery remains in the charger.

In another embodiment, the battery pack can receive a full charge cycle (bulk charge algorithm) periodically if the voltage of the pack falls to a particular level; e.g., between about 1.71 and 1.80 volts per cell.

### Alternate Charge Algorithms

Certain alternative charge algorithms may include a multi-stepped constant charge algorithm to defined voltage limits (e.g., temperature compensated voltage limits or temperature and current compensated voltage limits). In some examples, about ten steps are used. First a constant current is applied until the voltage reaches the defined voltage limit. Then the current is stepped down and held constant until the voltage again reaches the defined limit. The process may repeat until a defined level of charge is reached. This approach may be employed in cases where very simple chargers are employed, e.g., chargers that are incapable of performing a constant voltage charge. In one embodiment, each time the current is stepped down, it is stepped by a factor of about 10.

Other alternate charge algorithms involve charging at a constant current and then terminating the charge based on measured voltage, voltage and time, and/or temperature and time. In the first case the charge is terminated when the level of voltage decreases by dV from the maximum, which may be about 0 to 0.020 volts/cell in certain embodiments, preferably about 0 volts/cell. In the second case, the charge is terminated when the level of voltage decreases relative to time by the amount dV/dt. In other words, the charger will terminate the charge when voltage decreases by a pre-determined amount per cell within a specified time period. Alternatively, the charge may be terminated when the level of voltage does not change over a certain amount of time. Lastly, the charge may be terminated based on the amount of temperature increase relative to time, or dT/dt. In other words, the charger will terminate the charge when the battery temperature increases by a specified amount within a specified time period.

### The Battery Charger

A battery charger may use these algorithms singly or in combination. The logic required may be hardwired into the charger by using various electronic components, be programmed with a low cost programmable logic circuit (PLC), or be custom designed on a chip (e.g., an ASIC). One skilled in the art would be able to select the most economical way to deploy the required logic.

The charger may be directly integrated into the consumer product, as the logic may be programmed into the power tool or device powered by the battery. In some of those cases, the logic may be implemented in the electric circuitry within the consumer product, or be a separate module that may or may not be detachable.

The nickel-zinc charger may include an enclosure for holding the nickel-zinc battery, a thermistor configured to thermally couple to a battery during operation, and a controller configured to execute a set of instructions. The charger may also include a recondition button and/or other interface. The enclosure need not completely surround the battery, e.g., the enclosure may have an open face. The enclosure may also have a door or lid to allow for easy access to the battery and otherwise keep out dust. Depending on the size and shape of the battery, many designs exist for the enclosure of a stand alone battery charger.

During charging operations, the thermistor may contact an external surface of a cell in the thermal center of a battery pack. The thermistor may be rigidly or flexibly attached to the enclosure. In some cases, the thermistor may be inserted manually or automatically after the battery has correctly seated in the enclosure.

The set of instructions may include instructions to measure a temperature of the battery, calculate a calculated voltage, charge the battery at the calculated voltage, and stop the charge at the calculated voltage when an end-of-charge condition is detected. The instructions may also include instructions to charge the battery at a constant current, charge the battery at a corrective current, or charge the battery at a minimum current. The instructions may also include instructions to charge the battery at an initial current when the recondition button is pressed. Additionally, the charger may include other interface with which the user may interact with the charger or the charger may communicate with the user, e.g., color lights to indicate completion of charging or that the battery is bad.

### General Cell Structure

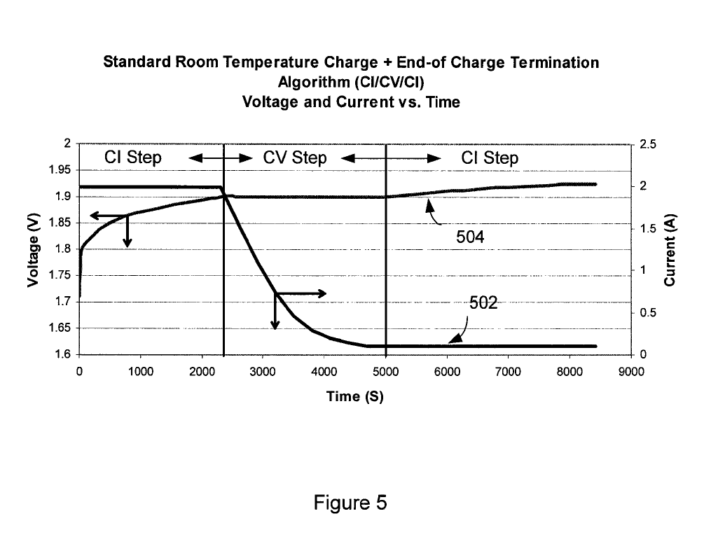

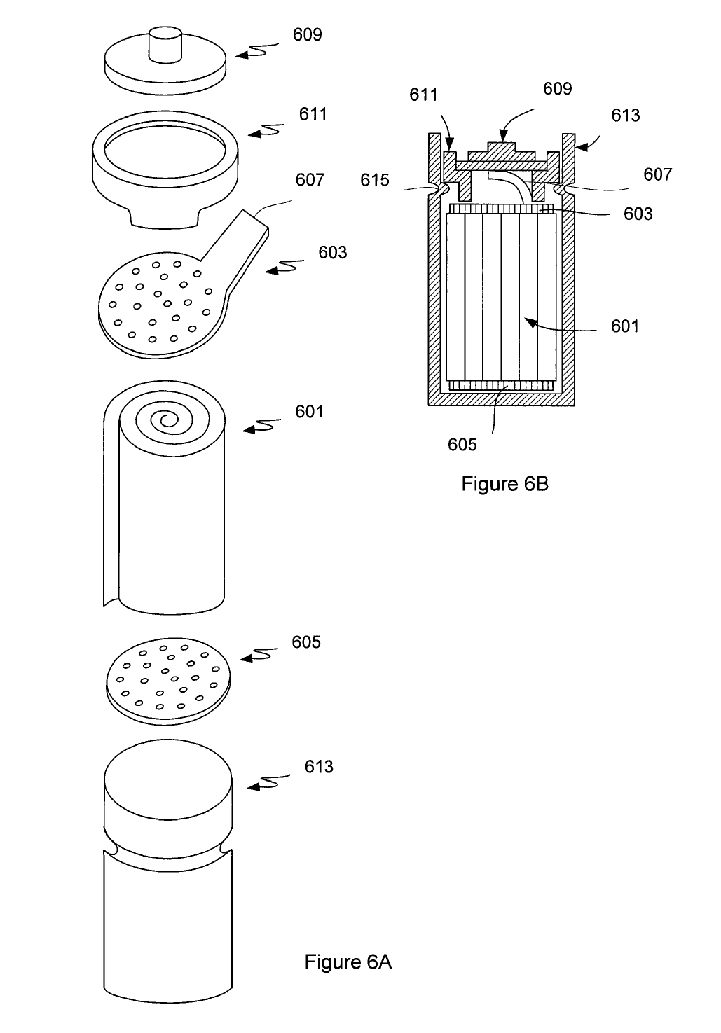

FIGS. 6A and 6B are graphical representations of the main components of a cylindrical power cell according to an embodiment of the invention, with FIG. 6A showing an exploded view of the cell. Alternating electrode and electrolyte layers are provided in a cylindrical assembly 601 (also called a “jellyroll”). The cylindrical assembly or jellyroll 601 is positioned inside a can 613 or other containment vessel. A negative collector disk 603 and a positive collector disk 605 are attached to opposite ends of cylindrical assembly 601. The negative and positive collector disks function as internal terminals, with the negative collector disk electrically connected to the negative electrode and the positive collector disk electrically connected to the positive electrode. A cap 609 and the can 613 serve as external terminals. In the depicted embodiment, negative collector disk 603 includes a tab 607 for connecting the negative collector disk 603 to cap 609. Positive collector disk 605 is welded or otherwise electrically connected to can 613. In other embodiments, the negative collector disk connects to the can and the positive collector disk connects to the cap.

The negative and positive collector disks 603 and 605 are shown with perforations, which may be employed to facilitate bonding to the jellyroll and/or passage of electrolyte from one portion of a cell to another. In other embodiments, the disks may employ slots (radial or peripheral), grooves, or other structures to facilitate bonding and/or electrolyte distribution.

A flexible gasket 611 rests on a circumferential bead 615 provided along the perimeter in the upper portion of can 613, proximate to the cap 609. The gasket 611 serves to electrically isolate cap 609 from can 613. In certain embodiments, the bead 615 on which gasket 611 rests is coated with a polymer coating. The gasket may be any material that electrically isolates the cap from the can. Preferably the material does not appreciably distort at high temperatures; one such material is nylon. In other embodiments, it may be desirable to use a relatively hydrophobic material to reduce the driving force that causes the alkaline electrolyte to creep and ultimately leak from the cell at seams or other available egress points. An example of a less wettable material is polypropylene.

After the can or other containment vessel is filled with electrolyte, the vessel is sealed to isolate the electrodes and electrolyte from the environment as shown in FIG. 6B. The gasket is typically sealed by a crimping process. In certain embodiments, a sealing agent is used to prevent leakage. Examples of suitable sealing agents include bituminous sealing agents, tar and VERSAMID® available from Cognis of Cincinnati, Ohio.

In certain embodiments, the cell is configured to operate in an electrolyte “starved” condition. Further, in certain embodiments, the nickel-zinc cells of this invention employ a starved electrolyte format. Such cells have relatively low quantities electrolyte in relation to the amount of active electrode material. They can be easily distinguished from flooded cells, which have free liquid electrolyte in interior regions of the cell. As discussed in U.S. patent application Ser. No. 11/116,113, filed Apr. 26, 2005, titled “Nickel Zinc Battery Design,” hereby incorporated by reference, it may be desirable to operate a cell at starved conditions for a variety of reasons. A starved cell is generally understood to be one in which the total void volume within the cell electrode stack is not fully occupied by electrolyte. In a typical example, the void volume of a starved cell after electrolyte fill may be at least about 10% of the total void volume before fill.

The battery cells of this invention can have any of a number of different shapes and sizes. For example, cylindrical cells of this invention may have the diameter and length of conventional AAA cells, AA cells, A cells, C cells, etc. Custom cell designs are appropriate in some applications. In a specific embodiment, the cell size is a sub-C cell size of diameter 22 mm and length 43 mm. Note that the present invention also may be employed in relatively small prismatic cell formats, as well as various larger format cells employed for various non-portable applications. Often the profile of a battery pack for, e.g., a power tool or lawn tool will dictate the size and shape of the battery cells. This invention also pertains to battery packs including one or more nickel zinc battery cells of this invention and appropriate casing, contacts, and conductive lines to permit charge and discharge in an electric device.

Note that the embodiment shown in FIGS. 6A and 6B has a polarity reverse of that in a conventional NiCd cell, in that the cap is negative and the can is positive. In conventional power cells, the polarity of the cell is such that the cap is positive and the can or vessel is negative. That is, the positive electrode of the cell assembly is electrically connected with the cap and the negative electrode of the cell assembly is electrically connected with the can that retains the cell assembly. In a certain embodiments of this invention, including that depicted in FIGS. 6A and 6B, the polarity of the cell is opposite of that of a conventional cell. Thus, the negative electrode is electrically connected with the cap and the positive electrode is electrically connected to the can. It should be understood that in certain embodiments of this invention, the polarity remains the same as in conventional designs—with a positive cap.

The can is the vessel serving as the outer housing or casing of the final cell. In conventional nickel-cadmium cells, where the can is the negative terminal, it is typically nickel-plated steel. As indicated, in this invention the can may be either the negative or positive terminal. In embodiments in which the can is negative, the can material may be of a composition similar to that employed in a conventional nickel cadmium battery, such as steel, as long as the material is coated with another material compatible with the potential of the zinc electrode. For example, a negative can may be coated with a material such as copper to prevent corrosion. In embodiments where the can is positive and the cap negative, the can may be a composition similar to that used in convention nickel-cadmium cells, typically nickel-plated steel.

In some embodiments, the interior of the can may be coated with a material to aid hydrogen recombination. Any material that catalyzes hydrogen recombination may be used. An example of such a material is silver oxide.

Venting Cap

Although the cell is generally sealed from the environment, the cell may be permitted to vent gases from the battery that are generated during charge and discharge. A typical nickel cadmium cell vents gas at pressures of approximately 200 Pounds per Square Inch (PSI). In some embodiments, a nickel zinc cell of this invention is designed to operate at this pressure and even higher (e.g., up to about 300 PSI) without the need to vent. This may encourage recombination of any oxygen and hydrogen generated within the cell. In certain embodiments, the cell is constructed to maintain an internal pressure of up to about 450 PSI and or even up to about 600 PSI. In other embodiments, a nickel zinc cell is designed to vent gas at relatively lower pressures. This may be appropriate when the design encourages controlled release of hydrogen and/or oxygen gases without their recombination within the cell.

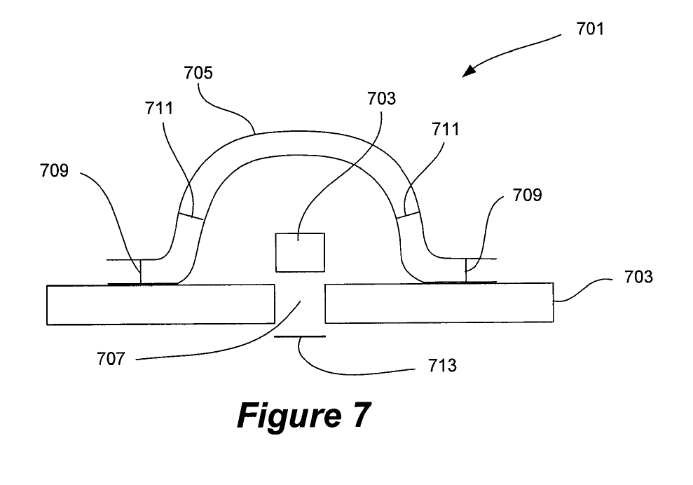

FIG. 7 is a representation of a cap 701 and vent mechanism according to one embodiment of the invention. The vent mechanism is preferably designed to allow gas but not electrolyte to escape. Cap 701 includes a disk 708 that rests on the gasket, a vent 703 and an upper portion 705 of cap 701. Disk 708 includes a hole 707 that permits gas to escape. Vent 703 covers hole 707 and is displaced by escaping gas. Vent 703 is typically rubber, though it may be made of any material that permits gas to escape and withstands high temperatures. A square vent has been found to work well. Upper portion 705 is welded to disk 708 at weld spots 709 and includes holes 711 to allow the gas to escape. The locations of weld spots 709 and 711 shown are purely illustrative and these may be at any suitable location. In a preferred embodiment, the vent mechanism includes a vent cover 713 made of a hydrophobic gas permeable membrane. Examples of vent cover materials include microporous polypropylene, microporous polyethylene, microporous PTFE, microporous FEP, microporous fluoropolymers, and mixtures and co-polymers thereof (see e.g., U.S. Pat. No. 6,949,310 (J. Phillips), “Leak Proof Pressure Relief Valve for Secondary Batteries,” issued Sep. 27, 2005, which is incorporated herein by reference for all purposes). The material should be able to withstand high temperatures.

In certain embodiments, hydrophobic gas permeable membranes are used in conjunction with a tortuous gas escape route. Other battery venting mechanisms are known in the art and are suitable for use with this invention. In certain embodiments, a cell's materials of construction are chosen to provide regions of hydrogen egress. For example, the cells cap or gasket may be made from a hydrogen permeable polymeric material. In one specific example, the outer annular region of the cell's cap is made from a hydrogen permeable material such as an acrylic plastic or one or more of the polymers listed above. In such embodiments, only the actual terminal (provided in the center of the cap and surrounded by the hydrogen permeable material) need be electrically conductive.

The Negative Electrode

Generally the negative electrode includes one or more electroactive sources of zinc or zincate ions optionally in combination with one or more additional materials such as conductivity enhancing materials, corrosion inhibitors, wetting agents, etc. as described below. When the electrode is fabricated it will be characterized by certain physical, chemical, and morphological features such as coulombic capacity, chemical composition of the active zinc, porosity, tortuosity, etc.

In certain embodiments, the electrochemically active zinc source may comprise one or more of the following components: zinc oxide, calcium zincate, zinc metal, and various zinc alloys. Any of these materials may be provided during fabrication and/or be created during normal cell cycling. As a particular example, consider calcium zincate, which may be produced from a paste or slurry containing, e.g., calcium oxide and zinc oxide.

If a zinc alloy is employed, it may in certain embodiments include bismuth and/or indium. In certain embodiments, it may include up to about 20 parts per million lead. A commercially available source of zinc alloy meeting this composition requirement is PG101 provided by Noranda Corporation of Canada.

The zinc active material may exist in the form of a powder, a granular composition, etc. Preferably, each of the components employed in a zinc electrode paste formulation has a relatively small particle size. This is to reduce the likelihood that a particle may penetrate or otherwise damage the separator between the positive and negative electrodes.

Considering electrochemically active zinc components in particular (and other particulate electrode components as well), such components preferably have a particle size that is no greater than about 40 or 50 micrometers. In certain embodiments, the material may be characterized as having no more than about 1% of its particles with a principal dimension (e.g., diameter or major axis) of greater than about 50 micrometers. Such compositions can be produced by, for example, sieving or otherwise treating the zinc particles to remove larger particles. Note that the particle size regimes recited here apply to zinc oxides and zinc alloys as well as zinc metal powders.

In addition to the electrochemically active zinc component(s), the negative electrode may include one or more additional materials that facilitate or otherwise impact certain processes within the electrode such as ion transport, electron transport (e.g., enhance conductivity), wetting, porosity, structural integrity (e.g., binding), gassing, active material solubility, barrier properties (e.g., reducing the amount of zinc leaving the electrode), corrosion inhibition etc.

For example, in some embodiments, the negative electrode includes an oxide such as bismuth oxide, indium oxide, and/or aluminum oxide. Bismuth oxide and indium oxide may interact with zinc and reduce gassing at the electrode. Bismuth oxide may be provided in a concentration of between about 1 and 10% by weight of a dry negative electrode formulation. It may facilitate recombination of hydrogen and oxygen. Indium oxide may be present in a concentration of between about 0.05 and 1% by weight of a dry negative electrode formulation. Aluminum oxide may be provided in a concentration of between about 1 and 5% by weight of a dry negative electrode formulation.

In certain embodiments, one or more additives may be included to improve corrosion resistance of the zinc electroactive material and thereby facilitate long shelf life. The shelf life can be critical to the commercial success or failure of a battery cell. Recognizing that batteries are intrinsically chemically unstable devices, steps should be taken to preserve battery components, including the negative electrode, in their chemically useful form. When electrode materials corrode or otherwise degrade to a significant extent over weeks or months without use, their value becomes limited by short shelf life.

Specific examples of anions that may be included to reduce the solubility of zinc in the electrolyte include phosphate, fluoride, borate, zincate, silicate, stearate, etc. Generally, these anions may be present in a negative electrode in concentrations of up to about 5% by weight of a dry negative electrode formulation. It is believed that at least certain of these anions go into solution during cell cycling and there they reduce the solubility of zinc. Examples of electrode formulations including these materials are included in the following patents and patent applications, each of which is incorporated herein by reference for all purposes: U.S. Pat. No. 6,797,433, issued Sep. 28, 2004, titled, “Negative Electrode Formulation for a Low Toxicity Zinc Electrode Having Additives with Redox Potentials Negative to Zinc Potential,” by Jeffrey Phillips; U.S. Pat. No. 6,835,499, issued Dec. 28, 2004, titled, “Negative Electrode Formulation for a Low Toxicity Zinc Electrode Having Additives with Redox Potentials Positive to Zinc Potential,” by Jeffrey Phillips; U.S. Pat. No. 6,818,350, issued Nov. 16, 2004, titled, “Alkaline Cells Having Low Toxicity Rechargeable Zinc Electrodes,” by Jeffrey Phillips; and PCT/NZ02/00036 (publication no. WO 02/075830) filed Mar. 15, 2002 by Hall et al.

Examples of materials that may be added to the negative electrode to improve wetting include titanium oxides, alumina, silica, alumina and silica together, etc. Generally, these materials are provided in concentrations of up to about 10% by weight of a dry negative electrode formulation. A further discussion of such materials may be found in U.S. Pat. No. 6,811,926, issued Nov. 2, 2004, titled, “Formulation of Zinc Negative Electrode for Rechargeable Cells Having an Alkaline Electrolyte,” by Jeffrey Phillips, which is incorporated herein by reference for all purposes.

Examples of materials that may be added to the negative electrode to improve electronic conductance include various electrode compatible materials having high intrinsic electronic conductivity. Examples include titanium oxides, etc. Generally, these materials are provided in concentrations of up to about 10% by weight of a dry negative electrode formulation. The exact concentration will depend, of course, on the properties of chosen additive.

Various organic materials may be added to the negative electrode for the purpose of binding, dispersion, and/or as surrogates for separators. Examples include hydroxylethyl cellulose (HEC), carboxymethyl cellulose (CMC), the free acid form of carboxymethyl cellulose (HCMC), polytetrafluoroethylene (PTFE), polystyrene sulfonate (PSS), polyvinyl alcohol (PVA), nopcosperse dispersants (available from San Nopco Ltd. of Kyoto Japan), etc.

In a specific example, PSS and PVA are used to coat the negative electrode to provide wetting or other separator-like properties. In certain embodiments, when using a separator-like coating for the electrode, the zinc-nickel cell may employ a single layer separator and in some embodiments, no independent separator at all.

In certain embodiments, polymeric materials such as PSS and PVA may be mixed with the paste formation (as opposed to coating) for the purpose of burying sharp or large particles in the electrode that might otherwise pose a danger to the separator.

When defining an electrode composition herein, it is generally understood as being applicable to the composition as produced at the time of fabrication (e.g., the composition of a paste, slurry, or dry fabrication formulation), as well as compositions that might result during or after formation cycling or during or after one or more charge-discharge cycles while the cell is in use such as while powering a portable tool.

Various negative electrode compositions within the scope of this invention are described in the following documents, each of which is incorporated herein by reference: PCT Publication No. WO 02/39517 (J. Phillips), PCT Publication No. WO 02/039520 (J. Phillips), PCT Publication No. WO 02/39521, PCT Publication No. WO 02/039534 and (J. Phillips), US Patent Publication No. 2002182501. Negative electrode additives in the above references include, for example, silica and fluorides of various alkaline earth metals, transition metals, heavy metals, and noble metals.

Finally, it should be noted that while a number of materials may be added to the negative electrode to impart particular properties, some of those materials or properties may be introduced via battery components other than the negative electrode. For example, certain materials for reducing the solubility of zinc in the electrolyte may be provided in the electrolyte or separator (with or without also being provided to the negative electrode). Examples of such materials include phosphate, fluoride, borate, zincate, silicate, stearate. Other electrode additives identified above that might be provided in the electrolyte and/or separator include surfactants, ions of indium, bismuth, lead, tin, calcium, etc.

U.S. patent application Ser. No. 10/921,062 (J. Phillips), filed Aug. 17, 2004, hereby incorporated by reference, describes a method of manufacturing a zinc negative electrode of the type that may be employed in the present invention.

Negative Electronic Conduction Pathway

The negative electronic pathway is comprised of the battery components that carry electrons between the negative electrode and the negative terminal during charge and discharge. One of these components is a carrier or current collection substrate on which the negative electrode is formed and supported. This is a subject of the present invention. In a cylindrical cell design, the substrate is typically provided within a spirally wound sandwich structure that includes the negative electrode material, a cell separator and the positive electrode components (including the electrode itself and a positive current collection substrate). As indicated, this structure is often referred to as a jellyroll. Other components of the negative electronic pathway are depicted in FIG. 1A. Typically, though not necessarily, these include a current collector disk (often provided with a conductive tab) and a negative cell terminal. In the depicted embodiment, the disk is directly connected to the negative current collector substrate and the cell terminal is directly attached to the current collector disk (often via the conductive tab). In a cylindrical cell design, the negative cell terminal is usually either a cap or a can.

Each of the components of the negative electronic conduction pathway may be characterized by its composition, electrical properties, chemical properties, geometric and structural properties, etc. For example, in certain embodiments, each element of the pathway has the same composition (e.g., zinc or zinc coated copper). In other embodiments, at least two of the elements have different compositions.

As indicated, an element of the conductive pathway that is the subject of this application is the carrier or substrate for the negative electrode, which also serves as a current collector. Among the criteria to consider when choosing a material and structure for the substrate are electrochemically compatible with the negative electrode materials, cost, ease of coating (with the negative electrode material), suppression of hydrogen evolution, and ability to facilitate electron transport between the electrochemically active electrode material and the current collector.

As explained, the current collection substrate can be provided in various structural forms including perforated metal sheets, expanded metals, metal foams, etc. In a specific embodiment, the substrate is a perforated sheet or an expanded metal made from a zinc based material such as zinc coated copper or zinc coated copper alloy. In certain embodiments, the substrate is a perforated sheet having a thickness between about 2 and 5 mils. In certain embodiments, the substrate is an expanded metal having a thickness between about 2 and 20 mils. In other embodiments, the substrate is a metal foam having a thickness of between about 15 and 60 mils. In a specific embodiment, the carrier is about 3-4 mils thick perforated zinc coated copper. A specific range for the thickness of the negative electrode, including the carrier metal and negative electrode material is about 10 to 24 mils.

Other components of the negative pathway, such as a negative current collector disk and cap, may be made from any of the base metals identified above for the current collection substrate. The base material chosen for the disk and/or cap should be highly conductive and inhibit the evolution of hydrogen, etc. In certain embodiments, one or both of the disk and the cap employs zinc or a zinc alloy as a base metal. In certain embodiments, the current collector disk and/or the cap is a copper or copper alloy coated with zinc or an alloy of zinc containing, e.g., tin, silver, indium, lead, or a combination thereof. It may be desirable to pre-weld the current collector disk and jelly roll or employ a jelly roll that is an integral part of the current collector disk and tab that could be directly welded to the top. Such embodiments may find particular value in relatively low rate applications. These embodiments are particularly useful when the collector disk contains zinc. The jelly roll may include a tab welded to one side of the negative electrode to facilitate contact with the collector disk.

It has been found that regular vent caps without proper anti-corrosion plating (e.g., tin, lead, silver, zinc, indium, etc.) can cause zinc to corrode during storage, resulting in leakage, gassing, and reduced shelf life. Note that if it is the can, rather than the cap, that is used as the negative terminal, then the can may be constructed from the materials identified above.

In some cases, the entire negative electronic pathway (including the terminal and one or more current collection elements) is made from the same material, e.g., zinc or copper coated with zinc. In a specific embodiment, the entire electronic pathway from the negative electrode to the negative terminal (current collector substrate, current collector disk, tab, and cap) is zinc plated copper or brass.

Some details of the structure of a vent cap and current collector disk, as well as the carrier substrate itself, are found in the following patent applications which are incorporated herein by reference for all purposes: PCT/US2006/015807 filed Apr. 25, 2006 and PCT/US2004/026859 filed Aug. 17, 2004 (publication WO 2005/020353 A3).

The Positive Electrode

The positive electrode generally includes an electrochemically active nickel oxide or hydroxide and one or more additives to facilitate manufacturing, electron transport, wetting, mechanical properties, etc. For example, a positive electrode formulation may include at least an electrochemically active nickel oxide or hydroxide (e.g., nickel hydroxide (Ni(OH)₂)), zinc oxide, cobalt oxide (CoO), cobalt metal, nickel metal, and a flow control agent such as carboxymethyl cellulose (CMC). Note that the metallic nickel and cobalt may be chemically pure or alloys. In certain embodiments, the positive electrode has a composition similar to that employed to fabricate the nickel electrode in a conventional nickel cadmium battery, although there may be some important optimizations for the nickel zinc battery system.

A nickel foam matrix is preferably used to support the electroactive nickel (e.g., Ni(OH)₂) electrode material. In one example, commercially available nickel foam by Inco, Ltd. may be used. The diffusion path to the Ni(OH)₂ (or other electrochemically active material) through the nickel foam should be short for applications requiring high discharge rates. At high rates, the time it takes ions to penetrate the nickel foam is important. The width of the positive electrode, comprising nickel foam filled with the Ni(OH)₂ (or other electrochemically active material) and other electrode materials, should be optimized so that the nickel foam provides sufficient void space for the Ni(OH)₂ material while keeping the diffusion path of the ions to the Ni(OH)₂ through the foam short. The foam substrate thickness may be may be between 15 and 60 mils. In a preferred embodiment, the thickness of the positive electrode, comprising nickel foam filled with the electrochemically active and other electrode materials, ranges from about 16-24 mils. In a particularly preferred embodiment, positive electrode is about 20 mils thick.

The density of the nickel foam should be optimized to ensure that the electrochemically active material uniformly penetrates the void space of the foam. In a preferred embodiment, nickel foam of density ranging from about 300-500 g/m² is used. An even more preferred range is between about 350-500 g/m². In a particularly preferred embodiment nickel foam of density of about 350 g/m² is used. As the width of the electrode layer is decreased, the foam may be made less dense to ensure there is sufficient void space. In a preferred embodiment, a nickel foam density of about 350 g/m² and thickness ranging from about 16-18 mils is used.

The Separator

A separator serves to mechanically isolate the positive and negative electrodes, while allowing ionic exchange to occur between the electrodes and the electrolyte. The separator also blocks zinc dendrite formation. Dendrites are crystalline structures having a skeletal or tree-like growth pattern (“dendritic growth”) in metal deposition. In practice, dendrites form in the conductive media of a power cell during the lifetime of the cell and effectively bridge the negative and positive electrodes causing shorts and subsequent loss of battery function.

Typically, a separator will have small pores. In certain embodiments described herein, the separator includes multiple layers. The pores and/or laminate structure may provide a tortuous path for zinc dendrites and therefore effectively bar penetration and shorting by dendrites. Preferably, the porous separator has a tortuosity of between about 1.5 and 10, more preferably between about 2 and 5. The average pore diameter is preferably at most about 0.2 microns, and more preferably between about 0.02 and 0.1 microns. Also, the pore size is preferably fairly uniform in the separator. In a specific embodiment, the separator has a porosity of between about 35 and 55% with one preferred material having 45% porosity and a pore size of 0.1 micron.

In a preferred embodiment, the separator comprises at least two layers (and preferably exactly two layers)—a barrier layer to block zinc penetration and a wetting layer to keep the cell wet with electrolyte, allowing ionic exchange. This is generally not the case with nickel cadmium cells, which employ only a single separator material between adjacent electrode layers.

Performance of the cell may be aided by keeping the positive electrode as wet as possible and the negative electrode relatively dry. Thus, in some embodiments, the barrier layer is located adjacent to the negative electrode and the wetting layer is located adjacent to the positive electrode. This arrangement improves performance of the cell by maintaining electrolyte in intimate contact with the positive electrode.

In other embodiments, the wetting layer is placed adjacent to the negative electrode and the barrier layer is placed adjacent to the positive electrode. This arrangement aids recombination of oxygen at the negative electrode by facilitating oxygen transport to the negative electrode via the electrolyte.

The barrier layer is typically a microporous membrane. Any microporous membrane that is ionically conductive may be used. Often a polyolefin having a porosity of between about 30 and 80 per cent, and an average pore size of between about 0.005 and 0.3 micron will be suitable. In a preferred embodiment, the barrier layer is a microporous polypropylene. The barrier layer is typically about 0.5-4 mils thick, more preferably between about 1.5 and 4 mils thick.

The wetting layer may be made of any suitable wettable separator material. Typically the wetting layer has a relatively high porosity e.g., between about 50 and 85% porosity. Examples include polyamide materials such as nylon-based as well as wettable polyethylene and polypropylene materials. In certain embodiments, the wetting layer is between about 1 and 10 mils thick, more preferably between about 3 and 6 mils thick. Examples of separate materials that may be employed as the wetting material include NKK VL100 (NKK Corporation, Tokyo, Japan), Freudenberg FS2213E, Scimat 650/45 (SciMAT Limited, Swindon, UK), and Vilene FV4365.

Other separator materials known in the art may be employed. As indicated, nylon-based materials and microporous polyolefins (e.g., polyethylenes and polypropylenes) are very often suitable.

The Electrolyte

The electrolyte should possess a composition that limits dendrite formation and other forms of material redistribution in the zinc electrode. Such electrolytes have generally eluded the art. But one that appears to meet the criterion is described in U.S. Pat. No. 5,215,836 issued to M. Eisenberg on Jun. 1, 1993, which is hereby incorporated by reference. A particularly preferred electrolyte includes (1) an alkali or earth alkali hydroxide present in an amount to produce a stoichiometric excess of hydroxide to acid in the range of about 2.5 to 11 equivalents per liter, (2) a soluble alkali or earth alkali fluoride in an amount corresponding to a concentration range of about 0.01 to 1 equivalents per liter of total solution, and (3) a borate, arsenate, and/or phosphate salt (e.g., potassium borate, potassium metaborate, sodium borate, sodium metaborate, and/or a sodium or potassium phosphate). In one specific embodiment, the electrolyte comprises about 4.5 to 10 equiv/liter of potassium hydroxide, from about 2 to 6 equiv/liter boric acid or sodium metaborate and from about 0.01 to 1 equivalents of potassium fluoride. A specific preferred electrolyte for high rate applications comprises about 8.5 equiv/liter of hydroxide, about 4.5 equivalents of boric acid and about 0.2 equivalents of potassium fluoride.

The invention is not limited to the electrolyte compositions presented in the Eisenberg patent. Generally, any electrolyte composition meeting the criteria specified for the applications of interest will suffice. Assuming that high power applications are desired, then the electrolyte should have very good conductivity. Assuming that long cycle life is desired, then the electrolyte should resist dendrite formation. In the present invention, the use of borate and/or fluoride containing KOH electrolyte along with appropriate separator layers reduces the formation of dendrites thus achieving a more robust and long-lived power cell.

In a specific embodiment, the electrolyte composition includes an excess of between about 3 and 5 equiv/liter hydroxide (e.g., KOH, NaOH, and/or LiOH). This assumes that the negative electrode is a zinc oxide based electrode. For calcium zincate negative electrodes, alternate electrolyte formulations may be appropriate. In one example, an appropriate electrolyte for calcium zincate has the following composition: about 15 to 25% by weight KOH, about 0.5 to 5.0% by weight LiOH.

According to various embodiments, the electrolyte may comprise a liquid and a gel. The gel electrolyte may comprise a thickening agent such as CARBOPOL® available from Noveon of Cleveland, Ohio. In a preferred embodiment, a fraction of the active electrolyte material is in gel form. In a specific embodiment, about 5-25% by weight of the electrolyte is provided as gel and the gel component comprises about 1-2% by weight CARBOPOL®.

In some cases, the electrolyte may contain a relatively high concentration of phosphate ion as discussed in U.S. patent application Ser. No. 11/346,861, filed Feb. 1, 2006 and incorporated herein by reference for all purposes.

Although various details have been omitted for clarity's sake, various design alternatives may be implemented. Therefore, the present examples are to be considered as illustrative and not restrictive, and the invention is not to be limited to the details given herein, but may be modified within the scope of the invention.

1. A method of charging a nickel-zinc battery comprising:
measuring a temperature of the battery,
calculating a calculated voltage based on at least the temperature of the battery,
charging the battery at a constant current until a measured battery voltage reaches the calculated voltage,
charging the battery at the calculated voltage, and
stopping the battery charging at the calculated voltage when an end-of-charge condition is satisfied;
wherein the battery comprises one or more cells.

2. The method of claim 1, wherein the constant current is about 1-2 amps per 2 Amp hour of capacity in the battery.

3. The method of claim 1, wherein the constant current charging operation increases a capacity of the battery to about 80%.

4. The method of claim 1, further comprising:
charging the battery at a corrective current to correct cell imbalance after charging the battery at the calculated voltage.

5. The method of claim 1, further comprising:
charging the battery at a minimum current to maintain charge during period when the battery is not in use and the end-of-charge condition has been satisfied.

6. The method of claim 1, further comprising:
charging the battery at an initial current until a start-of-charge condition is satisfied.

7. The method of claim 4, wherein the corrective current is about 50-200 milliamps per 2 Amp hour of capacity in the battery.

8. The method of claim 5, wherein the minimum current is about 0-50 milliamps per 2 Amp hour of capacity in the battery.

9. The method of claim 6, wherein the initial current is about 0-50 milliamps per 2 Amp hour of capacity in the battery.

10. The method of claim 1, wherein the end-of-charge condition is selected from the group consisting of:
a charging current of less than a defined current associated with a specified state-of-charge;
a lapse of 1.5 hours of charging at the calculated voltage;
a battery temperature increase of 15 degrees Celsius;
a charging current of more than about a defined threshold associated with a short circuit in the battery; and,
combinations thereof.

11. The method of claim 6, wherein the start-of charge condition is selected from the group consisting of:
(a) a battery temperature of 15 degrees Celsius;
(b) a battery voltage of about 1 volt per cell; and,
(c) a lapse of about 20 hours or more without meeting either of conditions (a) or (b).

12. The method of claim 1, further comprising
repeating the measuring, and the calculating during the charging.

13. A nickel-zinc battery charger comprising:
an enclosure for holding the nickel-zinc battery,
a thermistor configured to thermally couple to a battery during operation; and,
a controller configured to execute a set of instructions, the instructions comprising instructions to:
measure a temperature of the battery,
calculate a calculated voltage,
charge the battery at a constant current until a measured battery voltage equals the calculated voltage,
charge the battery at the calculated voltage, and
stop the charge at the calculated voltage when an end-of-charge condition is detected.

14. The battery charger of claim 13, further comprising:
a recondition button and wherein the instructions further comprises
charging the battery at an initial current when the recondition button is pressed.

15. The battery charger of claim 13, wherein the instructions further comprises instructions to
charge the battery at a corrective current.

16. The battery charger of claim 13, wherein the instructions further comprises instructions to
charge the battery at a minimum current.

17. A method of correcting nickel-zinc battery cell imbalance comprising:
providing a battery pack at greater than about 90% state-of-charge in a charger, and
charging the battery at a corrective current for about 30 minutes to 2 hours without limiting the voltage.

18. The method of claim 17, wherein the corrective current is about 50-200 milliamps per 2 Amp hour of capacity in the battery.

19. The method of claim 17, further comprising:
charging the battery at a minimum current until the battery is removed from the charger.

20. The method of claim 19, wherein the minimum current is 0-50 milliamps per 2 Amp hour of capacity in the battery.

21. A method of charging a battery comprising:
measuring a temperature of the battery,
measuring a voltage of the battery,
calculating a calculated voltage based on at least the temperature of the battery,
charging the battery at a charge current until the battery voltage equals the calculated voltage,
reducing the charging current by a defined factor,
charging the battery at the reduced charge current until the battery voltage equals the calculated voltage,
wherein the factor is about 2-10.

22. The method of claim 21, further comprising
repeating the reducing and charging the battery at the reduced charge operations to the same voltage level.

23. A method of charging a nickel-zinc cell, the method comprising:
(a) charging the nickel-zinc battery at a constant current until reaching a point at which (i) the cell's state of charge is at least about 70%, (ii) a nickel electrode of the cell has not yet begun to evolve oxygen at a substantial level, and (iii) the cell voltage is between about 1.88 and 1.93 volts; and
(b) charging the nickel-zinc battery at a constant voltage in the range of 1.88-1.93 until an end-of-charge condition is satisfied.

24. The method of claim 23, wherein charging the battery at a constant current is conducted at a current of up to about 4 Amps per 2 Amp hour battery capacity, and wherein the nickel-zinc battery employs an electrolyte having a conductivity of at least about 0.5 cm⁻¹ ohm⁻¹.

25. The method of claim 24, wherein charging the battery at a constant current is conducted until the cell voltage is between about 1.88 and 1.91 volts.
